(19) United States
(12) Patent Application Publication
(10) Pub. No.: US 2022/0240030 A1
(43) Pub. Date: Jul. 28, 2022

(54) HEARING AID

(71) Applicant: Sivantos Pte. Ltd., Singapore (SG)

(72) Inventors: Manuel Weiss, Erlangen (DE); Lit Song Glen Ding, Singapore (SG); Volker Goly, Erlangen (DE); Stefanie Beyfuss, Erlangen (DE)

(21) Appl. No.: 17/584,761

(22) Filed: Jan. 26, 2022

(30) Foreign Application Priority Data
Jan. 27, 2021 (DE) 10 2021 200 726.0

(51) Int. Cl. H04R 25/00

(52) U.S. Cl. CPC H04R 25/65; H04R 2460/11; H04R 2225/021

(57) ABSTRACT

A hearing aid, in particular a hearing aid device, has a housing with a housing wall, in which a microphone is arranged. The housing wall has a chamber like a pocket hole, which is acoustically coupled to the microphone, and into which an inlet open on the outer side of the housing opens. The chamber is expanded in comparison to the inlet.

### CROSS-REFERENCE TO RELATED APPLICATION

This application claims the priority, under 35 U.S.C. § 119, of German Patent Application DE 10 2021 200 726.0, filed Jan. 27, 2021; the prior application is herewith incorporated by reference in its entirety.

### FIELD AND BACKGROUND OF THE INVENTION

The invention relates to a hearing aid having a housing. The hearing aid is preferably a hearing aid device.

Persons who suffer from a loss of the sense of hearing typically use a hearing aid device. Ambient sound is usually acquired here by means of an electromechanical acoustic transducer. The acquired electrical signals are processed by means of an amplifier circuit and introduced by means of a further electromechanical transducer in the form of a receiver into the auditory canal of the person. The acquired sound signals are additionally usually processed, for which a signal processor of the amplifier circuit is typically used. The amplification is matched here to a possible hearing loss of the hearing aid wearer.

In order that the electromagnetic acoustic transducer is protected from environmental influences, it is typically located in a housing of the hearing aid device. In order that reliable acquisition of the ambient sound is possible in this case, an inlet is typically introduced into the housing, which opens into the surroundings of the electromagnetic acoustic transducer. However, it is possible here that foreign particles or a liquid, such as sweat or rain, will penetrate into the housing through the inlet and damage the components arranged therein. To avoid this, a membrane is typically used, by means of which the inlet is covered. However, it is possible here that the membrane will clog with solid particles, so that the ambient sound is blocked. In this case, to ensure the functional reliability again, it is necessary to disassemble the hearing aid and clean the membrane. Moreover, material and installation costs are increased because of the membrane.

### SUMMARY OF THE INVENTION

The invention is based on the object of specifying a particularly suitable hearing aid, wherein in particular a susceptibility to repair and/or production costs are reduced.

This object is achieved according to the invention by the features of the independent claim. Advantageous refinements and embodiments are the subject matter of the dependent claims.

The hearing aid is, for example, a headphone or comprises a headphone. However, the hearing aid is particularly preferably a hearing aid device. The hearing aid device is used to assist a person suffering from a loss of the sense of hearing. In other words, the hearing aid device is a medical device, by means of which, for example, a partial hearing loss is compensated for. The hearing aid device is, for example, a “receiver-in-the-canal” hearing aid device (RIC; ex-receiver hearing aid device); an “in-the-ear” hearing aid device; an “in-the-canal” hearing aid device (ITC), or a “complete-in-canal” hearing aid device (CIC), hearing aid spectacles, a pocket hearing aid device, a bone vibrator hearing aid device, or an implant. The hearing aid device is particularly preferably a “behind-the-ear” hearing aid device, which is worn behind a pinna.

The hearing aid is provided and configured to be worn on the human body. In other words, the hearing aid preferably comprises a holding device, by means of which fastening on the human body is possible. Alternatively, or in combination thereto, the hearing aid is suitably shaped. If the hearing aid is a hearing aid device, the hearing aid is provided and configured to be arranged, for example, behind the ear or inside an auditory canal. In particular, the hearing aid is wireless and is provided and configured to be inserted at least partially into an auditory canal. The hearing aid particularly preferably comprises an energy storage device, by means of which an energy supply is provided.

The hearing aid has a housing, which comprises a housing wall. In particular, the housing is designed to be closed, so that a cavity is enclosed by means of the housing. Preferably, essentially all further components of the hearing aid are arranged in the housing, at least preferably the energy storage device and/or possible electronics, such as an amplifier circuit. For example, the housing is produced integrally or particularly preferably from multiple components. The housing wall forms here, for example, one of the housing parts, such as a cover of the hearing aid, which is designed to be removable, for example. Alternatively thereto, the housing wall is a component of one of the housing parts, such as a shell of the housing, which is closed by means of a cover. In particular, the housing wall is not covered and is preferably visible in the intended state, thus when the hearing aid is worn. The housing, or at least the housing wall, is suitably manufactured from a plastic, in particular in a plastic injection molding method. A level of design freedom is thus comparatively high. A weight of the housing is also not increased excessively.

A microphone is arranged in the housing, thus in particular an electromechanical acoustic transducer. The microphone is used to acquire ambient sound and is suitable, in particular provided and configured, for this purpose. In particular, the microphone is connected electrically and/or for signaling to any possible electronics, in particular the amplifier circuit, or other electrical/electronic components of the hearing aid. The signals acquired by means of the microphone are suitably processed by means of these electronics.

The hearing aid particularly preferably comprises a further electromechanical acoustic transducer, in particular a receiver, by means of which emission of the signals processed by means of the possible amplifier circuit takes place. For example, the receiver is also arranged in the housing or a further housing. For example, a signaling connection of the two housings is produced here by means of a line, in particular if the hearing aid is an RIC hearing aid device.

The housing wall has a chamber, which is designed like a pocket hole, and thus contains an orifice. The chamber is, for example, at least partially tubular, and/or the course of the chamber is linear. The cross section of the chamber is preferably equal or at least greatest in the region of the orifice. The chamber is in particular free of further components and is therefore a cavity. In summary, the chamber is preferably empty in the intended use of the hearing aid and opens at the inner side of the housing. In other words, the chamber begins in the interior of the housing. Due to the design like a pocket hole, the chamber ends inside the housing wall and not at the outside of the housing. The chamber is acoustically coupled to the microphone. For example, the chamber is closed on the inside by means of the microphone, in particular a membrane of the microphone, which is coupled to an acoustic sensor. Alternatively thereto, a gap is formed between the microphone and the chambers, but the microphone is arranged in the region of the orifice of the chamber.

An inlet opens into the chamber, which is in particular configured to be tubular and/or is preferably introduced into the housing wall. The inlet is open on the outer side of the housing. An acoustic coupling of the microphone with the surroundings is thus provided via the chamber and the inlet, wherein initially the microphone is acoustically coupled via the chamber and the inlet with the surroundings, however.

The chamber is expanded in comparison to the inlet. In other words, the chamber has an enlarged cross section in comparison to the inlet. In particular, the cross section is produced here perpendicular to a straight line which is parallel to the course of the inlet. The cross section of the chamber protrudes, for example, only on one side of the inlet, a plurality of the sides, or preferably on all sides beyond the cross section of the inlet, so that the cross section of the inlet is completely covered by the cross section of the chamber.

Due to the expanded chamber, a surface tension of water droplets which are located in the chamber is increased in comparison to water droplets which are located in the inlet. Therefore, the water droplets which strike the housing from the outside and enter the inlet, for example, are held therein. In summary, it is possible for liquids to enter the inlet from the outer side. However, due to the prevailing capillary forces, the liquid is kept in the inlet and thus is kept out of the chamber. As a result, entry of liquids into the housing is avoided. Therefore, no damage occurs to the components arranged in the housing, such as the microphone, because of which a susceptibility to repair is decreased. No additional component is required for this purpose, so that material costs are not increased, on the one hand. Installation or maintenance thereof is also not required. After the drying of the liquid, the inlet is unblocked again here, so that the full functionality is ensured again by means of drying the hearing aid. Costly repair is therefore also not required in this case.

For example, a continuous transition takes place between the inlet and the chamber. Therefore, in particular the capillary forces gradually increase with deeper penetration of the liquid into the housing. However, the transition between the inlet and the chamber is particularly preferably stepped. In other words, an abrupt transition takes place between the inlet and the chamber. In this way, a noncontinuous increase of the capillary forces also occurs, so that the liquid does completely fill up the inlet, but is kept completely out of the chamber. In summary, if liquid is present, the inlet is completely filled with the liquid, whereas the chamber remains completely free of the liquid. It is thus possible to adapt the acoustic properties of the microphone or at least the further processing by means of the possible electronics/amplifier circuit thereto, because of which further operation of the hearing aid, although restricted, is possible even with a partially closed inlet. Moreover, due to the stepped transition, it is possible to produce the inlet and the chamber by means of different gates, if the housing, or at least the housing wall, is produced in a plastic injection molding method or another casting method. A production is therefore simplified.

For example, the course of the inlet and/or the chamber is essentially linear. Production is simplified in this way, and in particular two different gates are used for the production. For example, the angle between the chamber and the inlet is arbitrary. However, the angle between the course of the inlet and the chamber is particularly preferably essentially 90°. In other words, the inlet extends perpendicularly to the chamber. Penetration of liquids into the chamber is thus further prevented. A comparatively long section can also be formed by means of the inlet and the chamber in this way, thus a comparatively great length of the chamber and the inlet, which improves holding back of the liquid by means of the capillary forces. A high thickness of the housing wall is not required here, so that a material demand is decreased, on the one hand. A weight of the hearing aid is not increased, on the other hand.

For example, the cross section of the inlet is circular. The prevailing capillary forces are thus increased, which increases a probability of closure. The cross section of the inlet is particularly preferably elliptical. Even with a comparatively low housing wall thickness, a comparatively large area is thus uncovered by means of the inlet, so that entry of the ambient sound is improved. In particular, the cross section is formed essentially perpendicular to the course of the inlet and, for example, essentially parallel to the course of the chamber. In a further alternative, the cross section of the inlet is polygonal and, for example, triangular, rectangular, or square.

The cross section of the chamber is, for example, also elliptical. The cross section of the chamber is particularly preferably rectangular. In this way, manufacturing is simplified, and a stepped, thus abrupt transition between the inlet and the chamber is enabled in particular, so that the possible liquid is kept in the inlet. For example, the bottom of the chamber is level and essentially perpendicular to its course. The bottom of the chamber, which is like a pocket hole, is particularly preferably curved and thus rounded. Therefore, there are no sharp edges therein, and the chamber of the housing wall can be demolded comparatively easily from a possible gate.

For example, the inlet is expanded on the outside. This takes place, for example, in the form of a trumpet and/or funnel. An entry of ambient sound is thus simplified. In particular, continuous widening of the inlet takes place, so that undesired acoustic effects do not occur. For example, the inlet is designed to be essentially rotationally symmetrical with respect to its course. However, the inlet is particularly preferably widened on one side, so that a droplet shape is formed, or the course of the inlet is, for example, inclined with respect to a longitudinal axis of the housing. In particular, the orifice of the inlet in the intended state, thus when it is worn on the body, is located offset to the rear, thus in particular in the region of the back of the head, with respect to the alignment of the human, thus with respect to the longitudinal axis of the housing, in this case. Wind noises penetrating into the housing and acquired by means of the microphone are reduced in this way.

For example, the inlet ends or opens at a side wall, a front side, or a rear side of the housing, if the hearing aid is worn as intended. In other words, the housing wall is thus the side wall, the rear side/wall, or the front side/wall, which are each preferably arranged essentially vertically in the intended state of the hearing aid. Alternatively thereto, the opening of the inlet is introduced into an upper side of the housing, and the housing wall thus at least partially forms an upper side of the housing, which is preferably arranged essentially horizontally in the intended state of the hearing aid.

For example, only a single inlet is provided. However, the hearing aid particularly preferably comprises a second inlet, which opens into the outer side of the housing, and is preferably a component of the housing wall. The second inlet also opens into the chamber. Therefore, when one of the two inlets is filled up by means of the possible (undesired) liquid, for example, entry of ambient sound through the other of the two inlets is also still possible, so that the functionality of the hearing aid is at least partially maintained. Alternatively or in combination therewith, a directional characteristic of the microphone is provided by means of the two inlets, and the evaluation of the signals recorded by means of the microphone is adapted to the geometrical arrangement of the two inlets in relation to one another, thus their orifice on the outer side of the housing. The two inlets preferably extend on a shared straight line, wherein the chamber is located between them. The orifices of the two inlets are therefore on opposite outer sides of the housing, because of which a directional characteristic is improved. Closing of both inlets due to the same effect, for example prevailing rain, is also improbable in this way, so that functional reliability is increased.

Other features which are considered as characteristic for the invention are set forth in the appended claims.

Although the invention is illustrated and described herein as embodied in a hearing aid, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is an illustration showing a hearing aid according to the invention;

FIG. 2 is a perspective view of a detail of a housing of the hearing aid, having two inlets opening into a chamber;

FIG. 3 is a sectional view through the chamber showing a detail of the housing;

FIG. 4 is a side view showing a detail of one of the inlets of the housing;

FIGS. 5 and 6 are sectional views showing a form of the housing; and

FIG. 7 is an illustration showing a form during the production of the housing.

### DETAILED DESCRIPTION OF THE INVENTION

Parts corresponding to one another are provided with the same reference numerals in all figures.

Referring now to the figures of the drawings in detail and first, particularly to FIG. 1 thereof, there is shown a hearing aid 2 in a form of a hearing aid device, which is provided and configured to be worn behind an ear of a user (user, hearing aid wearer, wearer). In other words, it is a “behind-the-ear” hearing aid device. The hearing aid 2 contains a housing 4, which is manufactured from a plastic in an injection molding method. A microphone 6 is arranged inside the housing 4. The microphone 6 is coupled for signaling to electronics 8, which contains a signal processing unit (not shown in greater detail here) having an amplifier circuit and a signal processor. The electronics 8 are formed by means of circuit elements, for example, electrical and/or electronic components. The signal processor is a digital signal processor (DSP) and is connected for signaling via an A/D converter (not shown in greater detail) to the microphone 6.

A receiver 10 is coupled for signaling to the electronics 8. By means of the receiver 10, an (electrical) signal provided by means of the electronics 8 is converted during operation into an output sound, thus into soundwaves. These are introduced into a sound tube 12, one end of which is fastened on the housing 4. The other end of the sound tube 12 is enclosed by means of a dome 14, which is arranged in the intended state in an auditory canal (not shown in more detail here) of the user. The sound tube 12 is located here at a front end of the housing in a longitudinal direction 16, along which the housing 4 is aligned. The longitudinal direction 16 corresponds here to the viewing direction of a person when this person wears the hearing aid 2 as intended. The electronics 8, the microphone 6, and the receiver 10 are powered by means of a battery 18. The housing 4 has a housing wall 20, which forms part of the upper terminus of the housing 4 in the vertical direction and is located above the microphone 6 in the vertical direction.

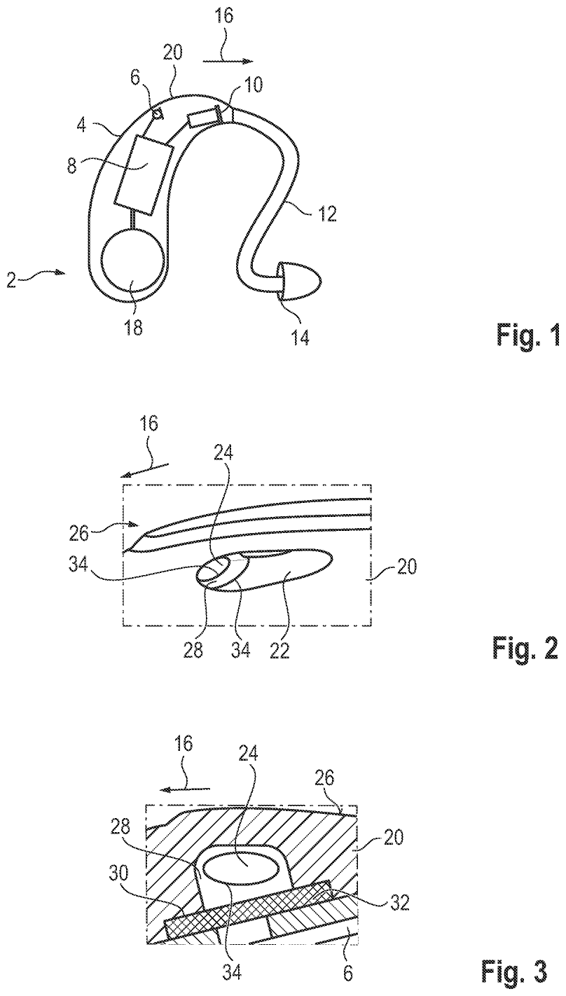

In FIG. 2, the housing wall 20, which is in one piece with further components of the housing 4, is shown in perspective and in FIG. 3 it is shown in a sectional illustration along the longitudinal direction 16. An inlet 22 and a second inlet 24 are introduced into the housing wall 20, which are open on an outer side 26 of the housing 4. The two inlets 22, 24 are tubular and open into a chamber 28, which is arranged perpendicularly to the course of the two inlets 22, 24 and extends essentially in the vertical direction. The chamber 28 is like a pocket hole and opens at an inner side 30 of the housing 4. The chamber 28 is closed there using a membrane 32 of the microphone 6. The chamber 28 is thus acoustically coupled to the microphone 6. By means of this, the soundwaves conducted through the chamber 28 are thus acquired, which enter therein through the two inlets 22, 24 from the outer side 26.

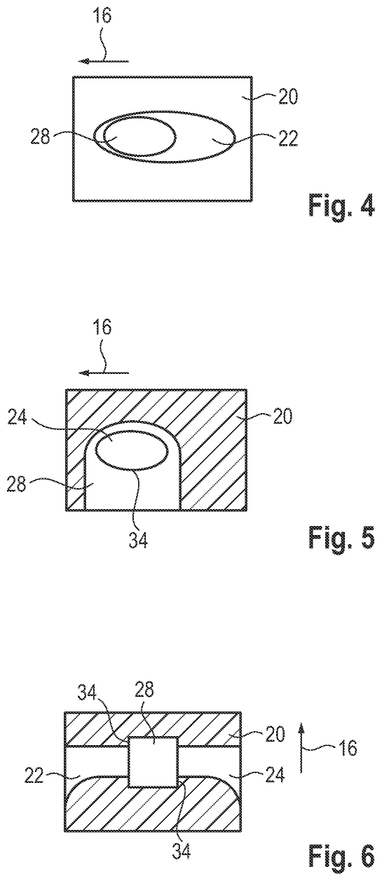

In FIG. 4, the housing wall 20 is shown in a schematically simplified side view of the inlet 22, in FIG. 5 it is shown in a schematically simplified sectional illustration according to FIG. 3, thus in a sectional illustration along the longitudinal direction 16, and in FIG. 6 it is shown in a sectional illustration in a horizontal plane. The chamber 28 is expanded in comparison to the two inlets 22, 24, which are mirror symmetrical with respect to the longitudinal axis 16. A circumferential step 34 is formed here between each of the orifices of the inlets 22, 24 into the chamber and the chamber 28, so that the transition between the inlets 22, 24 and the chamber 24 is stepped. In other words, the cross section of the chamber 28 is enlarged with respect to the orifice of the respective inlets 22, 24 and protrudes beyond them.

The cross section of the two inlets 22, 24, thus the section along the longitudinal axis 16, is elliptical, so that even with a comparatively low wall thickness, a comparatively large area is covered by means of the two inlets 22, 24. The end of each inlet 22, 24 opposite to the chamber 28 is widened like a funnel or trumpet here, wherein one of the ends of the ellipses, namely the respective rear end in the longitudinal direction 16, is made elongated. An entry of wind coming from the front in the longitudinal direction 16 into the two inlets 22, 24 is thus prevented or at least decreased, so that wind noises in the chamber 28 are reduced.

During operation, ambient sound enters the chamber 28 through the two inlets 22, 24 and is subsequently acquired by means of the microphone 16. Due to the two openings of the two inlets 22, 24 offset in relation to one another on the outer side 26 and with corresponding design of the electronics 8, it is possible to implement a directional effect by means of the microphone 6.

If a liquid, for example rain or sweat, strikes the housing wall 20 from the outer side 26, it is possible that it also reaches one of the two inlets 22, 24. Because of their funnel shape, which is required for the desired acquisition of the ambient sound, the liquid is suctioned due to the capillary effects into the respective inlet 22, 24, so that an entry of ambient sound into the chamber 28 and thus the functionality of the hearing aid 2 is reduced. Upon further entry of the liquid, the capillary forces suddenly increase at the step 34, so that the liquid does not enter the chamber 28, but rather remains in the respective inlet 22, 24. As a result, the liquid also does not strike the microphone 6, and it can be manufactured comparatively cost-effectively. The liquid can subsequently be removed from the respective inlet 22, 24 by means of drying the hearing aid 2, so that the hearing aid 2 is again ready for use without a complex repair. Moreover, due to the two inlets 22, 24, when one of them is filled up with the liquid, an entry of ambient sound into the chamber 28 through the respective remaining inlet 22, 24 is also possible, so that a further operation of the hearing aid 2 is possible, although restricted.

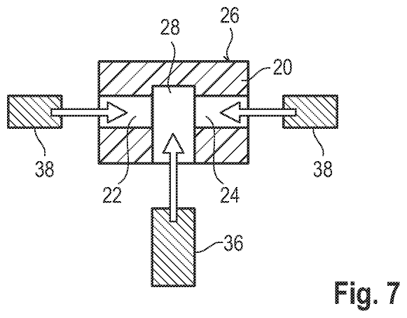

The cross section of the chamber 28 in the horizontal direction is square, wherein the bottom of the chamber 28, which is like a pocket hole, as shown in the sectional illustration in FIG. 3 and FIG. 5, is curved. In this way, it is possible to manufacture the housing wall 20 by means of multiple gates 36, 38 in an injection molding method, as schematically shown in FIG. 7. The housing wall 20 is shown here in a sectional illustration perpendicular to the longitudinal axis 16. Due to the curved bottom of the chamber 28, removal of a gate 36, by means of which the chamber 28 is molded, is simplified here. Two further gates 38 are also used for the production, which are used for molding the two inlets 22, 24 and are configured to be funnel-shaped.

To produce the housing wall 20 shown in FIG. 7 in a sectional illustration perpendicular to the longitudinal axis 16, the gate 36 is suitably positioned in a casting mold. Subsequently thereto, the two further gates 38 are moved toward the gate 36 from the opposite side and positioned in such a way that the gate 36 protrudes beyond the ends of the further gates 38. As a result, the gates 36, 38 are arranged corresponding to a lowercase “t” in the casting mold. A tolerance compensation is thus provided, on the one hand. On the other hand, it is possible to select the length of the two further gates 38, by means of which the two inlets 22, 24 are molded, and which are designed to be comparatively filigree, to be comparatively small, so that their robustness is increased. Excessive strain of certain corners or edges of the gates 38 also does not take place in this case, which would result in increased wear.

After completed positioning of the gates 36, 38, the casting mold is filled with plastic and subsequently cured. Subsequently thereto, the gates 36, 38 are each pulled out against the assigned arrow directions shown in FIG. 7. Since the two further gates 38 are supported on the gate 36, it is possible to detach their respective free ends without damaging the plastic forming the housing wall 20. Due to the curved bottom of the chamber 28, the gate 36 can subsequently be removed without deforming the housing wall 20.

The invention is not restricted to the above-described exemplary embodiment. Rather, other variants of the invention can be derived therefrom by a person skilled in the art without leaving the subject matter of the invention. In particular, all individual features described in conjunction with the exemplary embodiment are furthermore also combinable with one another in other ways without leaving the subject matter of the invention.

The following is a summary list of reference numerals and the corresponding structure used in the above description of the invention:
2 hearing aid
4 housing
6 microphone
8 electronics
10 receiver
12 sound tube
14 dome
16 longitudinal direction
18 battery
20 housing wall
22 inlet
24 second inlet
26 outer side
28 chamber
30 inner side
32 membrane
34 step
36 gate
38 further gate

1. A hearing aid, comprising:
a microphone; and
a housing having a housing wall and said microphone being disposed in said housing, wherein said housing wall containing a chamber shaped as a pocket hole, being acoustically coupled to said microphone, wherein said housing on an outer side having an inlet formed therein, and into said chamber said inlet opens, wherein said chamber is expanded in comparison to said inlet.

2. The hearing aid according to claim 1, wherein a transition between said inlet and said chamber is stepped.

3. The hearing aid according to claim 1, wherein said inlet extends perpendicularly to said chamber.

4. The hearing aid according to claim 1, wherein a cross section of said inlet is elliptical.

5. The hearing aid according to claim 1, wherein said inlet is expanded on said outer side.

6. The hearing aid according to claim 1, wherein said housing having a second inlet formed therein and opens into said chamber.

7. The hearing aid according to claim 1, wherein the hearing aid is a hearing aid device.
